(19) United States
(12) Patent Application Publication
(10) Pub. No.: US 2026/0247373 A1
(43) Pub. Date: Aug. 20, 2026

(54) NETWORK CONFIGURATION OF CYCLIC DELAY DIVERSITY FOR USER EQUIPMENT TRANSMISSIONS

(71) Applicant: QUALCOMM Incorporated, San Diego, CA (US)

(72) Inventors: Kangqi LIU, San Diego, CA (US); Hyojin LEE, San Diego, CA (US); Weimin DUAN, San Diego, CA (US)

(21) Appl. No.: 19/054,620

(22) Filed: Feb. 14, 2025

(51) Int. Cl. H04W 72/1268; H04W 72/54

(52) U.S. Cl. CPC H04W 72/1268; H04W 72/54

(57) ABSTRACT

Methods, systems, and devices for wireless communications are described. A user equipment (UE) may receive one or more indications of one or more delay values, which may be associated with a cyclic delay used for transmission diversity. Each of the one or more delay values may be associated with a respective antenna port of a set of antenna ports. The UE may transmit an uplink transmission based on generating a first signal for transmission using a first antenna port of the set of antenna ports and generating one or more second signals for transmission using a respective second antenna port of the set of antenna ports. Each of the one or more second signals may have a respective delay relative to the first signal in accordance with the one or more delay values.

### FIELD OF TECHNOLOGY

The following relates to wireless communications, including network configuration of cyclic delay diversity for user equipment (UE) transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, at the UE, one or more indications of one or more delay values, each of the one or more delay values associated with a respective antenna port of a set of multiple antenna ports and transmitting, from the UE, an uplink transmission based on generating a first signal for transmission using a first antenna port of the set of multiple antenna ports and generating one or more second signals for transmission using a respective second antenna port of the set of multiple antenna ports, each of the one or more second signals having a respective delay relative to the first signal in accordance with the one or more delay values.

A UE for wireless communications is described. The UE may include one or more memories storing processor executable code, and one or more processors coupled with the one or more memories. The one or more processors may individually or collectively be operable to execute the code to cause the UE to receive, at the UE, one or more indications of one or more delay values, each of the one or more delay values associated with a respective antenna port of a set of multiple antenna ports and transmit, from the UE, an uplink transmission based on generation of a first signal for transmission using a first antenna port of the set of multiple antenna ports and generation of one or more second signals for transmission using a respective second antenna port of the set of multiple antenna ports, each of the one or more second signals having a respective delay relative to the first signal in accordance with the one or more delay values.

Another UE for wireless communications is described. The UE may include means for receiving, at the UE, one or more indications of one or more delay values, each of the one or more delay values associated with a respective antenna port of a set of multiple antenna ports and means for transmitting, from the UE, an uplink transmission based on generating a first signal for transmission using a first antenna port of the set of multiple antenna ports and generating one or more second signals for transmission using a respective second antenna port of the set of multiple antenna ports, each of the one or more second signals having a respective delay relative to the first signal in accordance with the one or more delay values.

A non-transitory computer-readable medium storing code for wireless communications at a UE is described. The code may include instructions executable by one or more processors to receive, at the UE, one or more indications of one or more delay values, each of the one or more delay values associated with a respective antenna port of a set of multiple antenna ports and transmit, from the UE, an uplink transmission based on generating a first signal for transmission using a first antenna port of the set of multiple antenna ports and generating one or more second signals for transmission using a respective second antenna port of the set of multiple antenna ports, each of the one or more second signals having a respective delay relative to the first signal in accordance with the one or more delay values.

In some examples of the method, UEs, and non-transitory computer-readable medium described herein, receiving the one or more indications may include operations, features, means, or instructions for receiving a first indication of a default delay associated with the respective second antenna port and receiving a second indication of a delay offset associated with the respective second antenna port, the respective delay corresponding to a sum of the default delay and the delay offset.

In some examples of the method, UEs, and non-transitory computer-readable medium described herein, receiving the one or more indications may include operations, features, means, or instructions for receiving a first indication of an average delay associated with the respective second antenna port and receiving a second indication of a bounding value associated with the respective second antenna port, the respective delay being determined by the UE to be within the bounding value of the average delay.

In some examples of the method, UEs, and non-transitory computer-readable medium described herein, receiving the one or more indications may include operations, features, means, or instructions for receiving an indication of an average delay associated with the respective second antenna port, the respective delay being determined by the UE to be within a configured range of the average delay.

Some examples of the method, UEs, and non-transitory computer-readable medium described herein may further include operations, features, means, or instructions for receiving a configuration for sounding reference signal transmission and transmitting one or more sounding reference signals (SRSs) in accordance with the configuration, where receiving the one or more indications of the one or more delay values may be based on transmitting the one or more SRSs in accordance with the configuration.

In some examples of the method, UEs, and non-transitory computer-readable medium described herein, receiving the one or more indications may include operations, features, means, or instructions for receiving a first indication of a first delay value via a first type of control signaling and receiving a second indication of a second delay value via a second type of control signaling and transmitting the uplink transmission may be based on receiving the first indication and the second indication.

Some examples of the method, UEs, and non-transitory computer-readable medium described herein may further include operations, features, means, or instructions for receiving a configured grant that allocates a set of resources for uplink transmissions, where receiving at least one of the one or more indications may be based on receiving the configured grant.

Some examples of the method, UEs, and non-transitory computer-readable medium described herein may further include operations, features, means, or instructions for receiving, at the UE, one or more second indications of one or more second delay values, each of the one or more second delay values associated with a respective antenna port of the set of multiple antenna ports and transmitting, from the UE, a second uplink transmission based on generating a third signal for transmission using the first antenna port and generating one or more fourth signals for transmission using a respective second antenna port of the set of multiple antenna ports, each of the one or more fourth signals having a respective second delay relative to the third signal in accordance with the one or more second delay values.

A method for wireless communications by a network entity is described. The method may include outputting, from the network entity, one or more indications of one or more delay values for a UE, each of the one or more delay values associated with a respective antenna port of a set of multiple antenna ports and obtaining, at the network entity, an uplink transmission from the UE based on outputting the one or more indications of the one or more delay values for the UE.

A network entity for wireless communications is described. The network entity may include one or more memories storing processor executable code, and one or more processors coupled with the one or more memories. The one or more processors may individually or collectively be operable to execute the code to cause the network entity to output, from the network entity, one or more indications of one or more delay values for a UE, each of the one or more delay values associated with a respective antenna port of a set of multiple antenna ports and obtain, at the network entity, an uplink transmission from the UE based on output of the one or more indications of the one or more delay values for the UE.

Another network entity for wireless communications is described. The network entity may include means for outputting, from the network entity, one or more indications of one or more delay values for a UE, each of the one or more delay values associated with a respective antenna port of a set of multiple antenna ports and means for obtaining, at the network entity, an uplink transmission from the UE based on outputting the one or more indications of the one or more delay values for the UE.

A non-transitory computer-readable medium storing code for wireless communications at a network entity is described. The code may include instructions executable by one or more processors to output, from the network entity, one or more indications of one or more delay values for a UE, each of the one or more delay values associated with a respective antenna port of a set of multiple antenna ports and obtain, at the network entity, an uplink transmission from the UE based on outputting the one or more indications of the one or more delay values for the UE.

In some examples of the method, network entities, and non-transitory computer-readable medium described herein, the uplink transmission may be based on a first signal for transmission using a first antenna port of the set of multiple antenna ports and one or more second signals for transmission using a respective second antenna port of the set of multiple antenna ports, each of the one or more second signals having a respective delay relative to the first signal in accordance with the one or more delay values.

In some examples of the method, network entities, and non-transitory computer-readable medium described herein, outputting the one or more indications may include operations, features, means, or instructions for outputting a first indication of a default delay associated with a respective antenna port and outputting a second indication of a delay offset associated with the respective antenna port.

In some examples of the method, network entities, and non-transitory computer-readable medium described herein, outputting the one or more indications may include operations, features, means, or instructions for outputting a first indication of an average delay associated with a respective antenna port and outputting a second indication of a bounding value associated with the respective antenna port.

In some examples of the method, network entities, and non-transitory computer-readable medium described herein, outputting the one or more indications may include operations, features, means, or instructions for outputting an indication of an average delay associated with a respective antenna port.

Some examples of the method, network entities, and non-transitory computer-readable medium described herein may further include operations, features, means, or instructions for outputting a configuration for SRS transmission and obtaining one or more SRSs in response to outputting the configuration, where outputting the one or more indications of the one or more delay values may be based on obtaining the one or more SRSs.

In some examples of the method, network entities, and non-transitory computer-readable medium described herein, outputting the one or more indications may include operations, features, means, or instructions for outputting a first indication of a first cyclic delay value via a first type of control signaling and outputting a second indication of a second cyclic delay value via a second type of control signaling.

Some examples of the method, network entities, and non-transitory computer-readable medium described herein may further include operations, features, means, or instructions for outputting a configured grant that allocates a set of resources for uplink transmissions, where outputting at least one of the one or more indications may be based on outputting the configured grant.

Some examples of the method, network entities, and non-transitory computer-readable medium described herein may further include operations, features, means, or instructions for outputting, from the network entity, one or more second indications of one or more second delay values for the user equipment, each of the one or more second delay values associated with a respective antenna port of the set of multiple antenna ports and obtaining, at the network entity, a second uplink transmission from the UE based on outputting the one or more second indications of the one or more second delay values for the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports network configuration of cyclic delay diversity (CDD) for user equipment (UE) transmissions in accordance with one or more aspects of the present disclosure.

FIG. 2 shows an example of a wireless communications system that supports network configuration of CDD for UE transmissions in accordance with one or more aspects of the present disclosure.

FIG. 3 shows examples of resource diagrams that support network configuration of CDD for UE transmissions in accordance with one or more aspects of the present disclosure.

FIG. 4 shows an example of a process flow that supports network configuration of CDD for UE transmissions in accordance with one or more aspects of the present disclosure.

FIGS. 5 and 6 show block diagrams of devices that support network configuration of CDD for UE transmissions in accordance with one or more aspects of the present disclosure.

FIG. 7 shows a block diagram of a communications manager that supports network configuration of CDD for UE transmissions in accordance with one or more aspects of the present disclosure.

FIG. 8 shows a diagram of a system including a device that supports network configuration of CDD for UE transmissions in accordance with one or more aspects of the present disclosure.

FIGS. 9 and 10 show block diagrams of devices that support network configuration of CDD for UE transmissions in accordance with one or more aspects of the present disclosure.

FIG. 11 shows a block diagram of a communications manager that supports network configuration of CDD for UE transmissions in accordance with one or more aspects of the present disclosure.

FIG. 12 shows a diagram of a system including a device that supports network configuration of CDD for UE transmissions in accordance with one or more aspects of the present disclosure.

FIGS. 13 through 18 show flowcharts illustrating methods that support network configuration of CDD for UE transmissions in accordance with one or more aspects of the present disclosure.

### DETAILED DESCRIPTION

In some wireless communication systems, a user equipment (UE) may use one or more delay values (e.g., one or more cyclic delay diversity (CDD) values, such as a small delay-CDD (SD-CDD) or large delay-CDD (LD-CDD)) to increase a reliability of transmissions by the UE. For instance, delay values may be applied to different instances (e.g., copies) of a same signal before transmission via different antennas (e.g., different antenna ports). Such techniques may leverage a multipath propagation characteristic of a wireless channel to increase transmission diversity (e.g., by transmitting the same signal via multiple spatial paths that may have different channel characteristics), which may improve the robustness of a communication link (e.g., increase a likelihood of successful reception at a receiver). However, in some instances, a network may be unaware of whether a UE applies a delay value or not (e.g., the delay may be undetectable by a network entity), which may result in misalignment during communications between the network entity and the UE. Additionally, in some cases, a UE may leverage a downlink channel to determine delay values for transmissions (e.g., uplink transmissions, using channel reciprocity). However, channel reciprocity characteristics may not yield accurate results at the UE in some wireless communication deployments (e.g., in flexible or non-contiguous spectrum implementations).

In accordance with various aspects described herein, a network entity may be configured to determine (e.g., configure, compute, identify) various delay values (e.g., CDD values, SD-CDD values) for respective antennas (e.g., antenna ports) at a UE and output (e.g., transmit, indicate, signal) the delay values to the UE. As such, the UE may transmit one or more transmissions via respective antenna ports (e.g., concurrently) based on generation of various signals (e.g., one or more copies of a same signal, which may have different timing relative to one another) in accordance with the received delay values. In some examples, the network entity may determine one or more delay values based on one or more reference signals (e.g., sounding reference signals (SRSs)) transmitted by the UE.

In some examples, the UE may receive a default delay value (e.g., a relatively static value) and an offset value (e.g., a relatively dynamic value) from the network entity and may use such values to generate delayed signals for transmission. Additionally, or alternatively, the UE may receive an indication of an average delay value and the UE may determine a delay value that is within a range of the average delay value. Thus, by using the signaling mechanisms and other aspects herein, the UE and the network entity may support improved communication reliability, improved coordination between devices, and improved adaptability to dynamic wireless channel conditions, among other benefits for a wireless communications system.

Aspects of the disclosure are initially described in the context of wireless communications systems. Aspects of the disclosure are further illustrated by and described with reference to resource diagrams, process flows, apparatus diagrams, system diagrams, and flowcharts that relate to network configuration of CDD for UE transmissions.

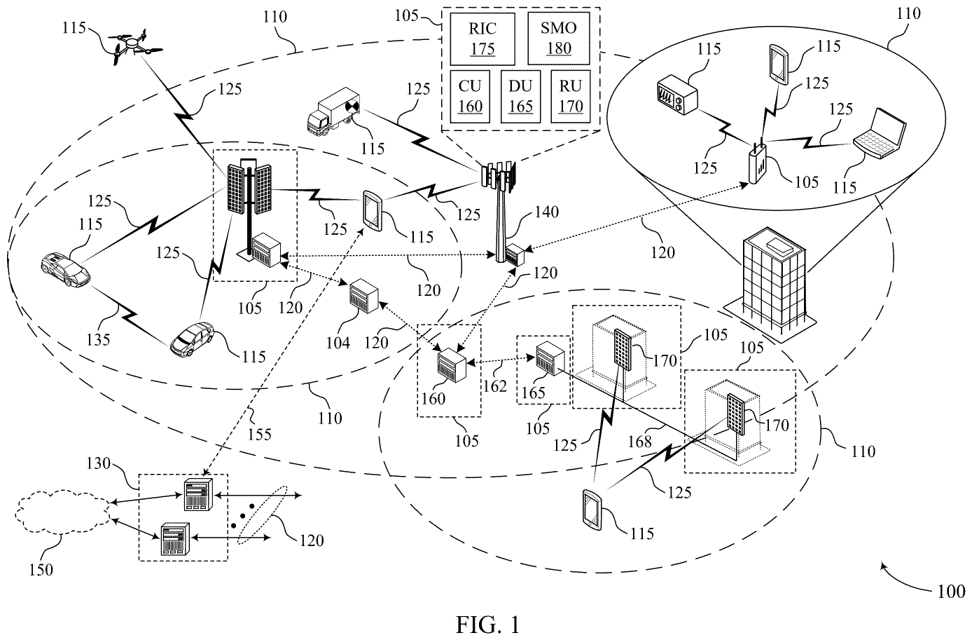

FIG. 1 shows an example of a wireless communications system 100 that supports network configuration of CDD for UE transmissions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support network configuration of CDD for UE transmissions as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, such as a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a UE 115 may use one or more delay values (e.g., one or more CDD values, one or more SD-CDD values, one or more LD-CDD values) to increase a reliability of transmissions by the UE 115. For example, such techniques may improve the robustness of a communication link by increasing a likelihood of successful reception at a receiver (e.g., the network entity 105). However, in some instances, the network entity 105 may be unaware of whether the UE 115 applies a delay value or does not apply a delay value (e.g., the delay may be undetectable by the network entity 105), resulting in misaligned communications. Further, in some cases, channel reciprocity characteristics used by the UE 115 for determining delay values may not be accurate for some deployments (e.g., in flexible or non-contiguous spectrum implementations).

In accordance with various aspects described herein, the network entity 105 may be enabled to determine (e.g., configure, compute, identify) various delay values (e.g., CDD values, SD-CDD values) for respective antennas (e.g., antenna ports) at one or more UEs 115 and output (e.g., transmit, indicate, signal) the delay values to the one or more UEs 115. As such, a UE 115 may transmit one or more transmissions (e.g., uplink transmissions, sidelink transmissions) via respective antenna ports using the configured values received from the network entity 105. In some examples, the UE 115 may receive a default delay value (e.g., a relatively static value) and an offset value (e.g., a relatively dynamic value) from the network entity 105, and the UE 115 may use these values to generate one or more delayed signals for transmission (e.g., in accordance with concurrent transmissions using multiple antennas). Additionally, or alternatively, the UE 115 may receive an indication of an average delay value and determine one or more delay values that are within a range of the average delay value. Thus, by using the signaling mechanisms and other aspects herein, UEs 115 and network entities 105 may support improved communication reliability, improved device coordination, and improved adaptability to communicate in dynamic wireless channel conditions, among other benefits for the wireless communications system 100.

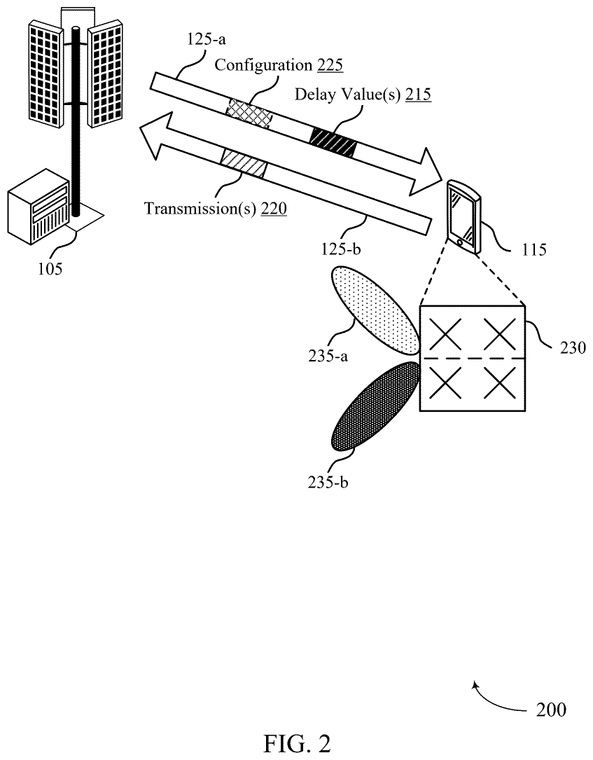

FIG. 2 shows an example of a wireless communications system 200 that supports network configuration of CDD for UE transmissions in accordance with one or more aspects of the present disclosure. The wireless communications system 200 may implement or be implemented by aspects of a wireless communications system 100. For example, the wireless communications system 200 may include a UE 115 (e.g., or multiple UEs 115) and a network entity 105 (e.g., or multiple network entities 105), which may be examples of corresponding devices as described with reference to FIG. 1. Although a network entity 105 and a UE 115 are shown as example devices of the wireless communications system 200, the techniques herein may be applied by one or more other devices described herein, including with reference to FIG. 1.

The network entity 105 and the UE 115 may communicate (e.g., transmit, receive, obtain, output, convey) various signaling (e.g., messages, indications) via one or more link(s) 125, such as the link 125-a (e.g., a downlink communication channel) and the link 125-b (e.g., and uplink communication channel). For example, as described herein, the UE 115 may receive one or more indications of one or more delay values 215 and a configuration 225 via the link 125-a and may transmit one or more transmissions 220 (e.g., uplink transmissions) via the link 125-b.

In some cases, devices of the wireless communications system 200 may implement diversity schemes to increase a likelihood of successful communications (e.g., successful decoding at a receiving device). Some devices may use diversity schemes to transmit data (e.g., broadcast data), control channel information, and other signaling. In some cases, diversity schemes may be used prior to an RRC connection establishment (e.g., to increase connection reliability). Additionally, or alternatively, diversity schemes may be a fallback mechanism in case of unreliable channel feedback (e.g., channel state information (CSI) feedback, including for relatively high-speed scenarios). Diversity schemes may also increase performance (e.g., a diversity order), have relatively low overhead (e.g., demodulation reference signal (DMRS) overhead), and may be associated with (e.g., consistent with) DMRS transmission (e.g., to simplify interference estimation).

Some diversity schemes may be based on spatial diversity, such as spatial frequency block codes (SFBC). In some cases, SFBC may be associated with two-port MIMO (e.g., two-port DMRS may be used). For example, an antenna array 230 (e.g., an antenna module, an antenna panel, multiple antennas, multiple transmit elements) at the UE 115 may support two or more antenna ports for various communications. In some examples, two ports may apply to one or more polarizations, one or more panels, or one or more beams 235 (e.g., in case of massive MIMO), among other antenna configurations. In one example, a first polarization (e.g., a positive polarization) may transmit via a beam 235-a and a second polarization (e.g., a negative polarization) may transmit via a beam 235-b (e.g., where each polarization is associated with a respective antenna port). In some cases, an “antenna port” may refer to a virtual or logical interface through which a device (e.g., a UE 115) may transmit or receive wireless signals. Each antenna port may represent a unique communication path with specific signal characteristics such as beamforming, polarization, or spatial properties. In some cases, antenna ports may support communication techniques, such as MIMO, to enhance data rates and reliability.

In another example, the antenna array 230 may be subdivided into two or more sub-arrays, and a first sub-array may transmit via the beam 235-a and a second sub-array may transmit via the beam 235-b (e.g., where each sub-array is associated with a respective antenna port. In yet another example, an entirety of the antenna array 230 may transmit via beam 235-a and via beam 235-b (e.g., where each antenna port is associated with a respective combination of beam parameters, such as beamforming coefficients, and signal parameters).

In some cases, SFBC may not be supported for some technologies (e.g., NR data channels) due to the use of two antenna ports for transmitting via a single layer. For example, to achieve spectral efficiency, multi-layer spatial multiplexing transmission may be used in some NR techniques. Additionally, or alternatively, a multi-port transmission scheme and inconsistency between data signal and DMRS transmission may increase implementation complexity at the UE 115, or may constrain an application of an interference-aware advanced receiver.

Additionally, or alternatively, devices of the wireless communications system 200 may implement a diversity scheme that is based on one or more CDD mechanisms in which a respective delay value is applied to one or more instances (e.g., copies, repetitions) of a same signal before transmitting the signal via various antennas elements (e.g., different antenna ports). For instance, after modulation (e.g., OFDM modulation) a same signal may be transmitted via multiple antenna ports, and a different delay value may be applied to a signal instance before transmission using the respective antenna port. The output signal may be represented as

$${s}_{i} ( k ) = \frac{1}{\sqrt{{N}_{T}}} \cdot {\tilde{s}}_{i} ( k - {δ}_{i} ) ,$$

for i=0, . . . , N_{T}-1, where δᵢ is a delay value, k is a time domain index, and N_{T} is the quantity of antenna ports used to transmit the signal sᵢ(k). In some cases, CDD mechanisms may include SD-CDD values, which may be relatively small (e.g., below a threshold), or LD-CDD values, which may be relatively large (e.g., above a threshold), or both. In some cases, SD-CDD may be supported in a transparent manner. For example, for some LTE and NR implementations, channel estimation may be performed without an accurate delay spread estimation.

Various signal processing steps may be used for processing CDD signals. For instance, one or more signals (e.g., transmission signals, reception signals) may have a quantity, N_{FFT}, of data symbols (e.g., in a frequency domain), S(l), where l=0, . . . , N_{FFT}-1. An inverse fast Fourier transform (IFFT) operation may be performed on the data symbols followed by an application of a delay value and of a cyclic prefix, which may result in a signal (e.g., a time domain signal) represented as

$${s}_{i} ( k ) = \frac{1}{\sqrt{{N}_{T}}} \cdot {\tilde{s}}_{i} ( k - {δ}_{i}^{cyc} mod {N}_{FFT} )$$

for i=0, . . . , N_{T}-1 and k=−N_{G}, . . . , N_{FFT}-1. In some cases, a delay (e.g., a maximum delay) after applying a CDD may be equal to

$$[ ( {δ}_{max}^{cyc} + {N}_{max} ) mod {N}_{FFT} ] \times {τ}_{s} , where {δ}_{max}^{cyc} = {max}_{i} {δ}_{i}^{cyc} ,$$

Nₘₐₓ may be a maximum channel delay in terms of samples, and τₛ may be sampling rate. Subsequently, the cyclic prefix may be removed and a fast Fourier transform (FFT) operation may be performed on the time domain signal at a receiver (e.g., a UE 115, a network entity 105). Based on the FFT operation, the receiver may obtain the received signal, which may be represented as

$$R ( l ) = [ \frac{1}{\sqrt{{N}_{T}}} {\sum }_{i = 0}^{{N}_{T} - 1} {e}^{- j \frac{2 π}{{N}_{FFT}} {δ}_{i}^{cyc} l} {H}_{i} ( l ) ] S ( l ) + N ( l ) ,$$

where Hᵢ(l) represents a channel estimation from the i-th antenna and N(l) represents random noise introduced during transmission (e.g., the term,

$${\sum }_{i = 0}^{{N}_{T} - 1} {e}^{- j \frac{2 π}{{N}_{FFT}} {δ}_{i}^{cyc} l} {H}_{i} ( l ) ,$$

may also represent an effective channel, H(l)).

In some cases (e.g., for SD-CDD), channel estimation procedures may be based on a delay spread (e.g., a maximum delay,

$${δ}_{max}^{cyc} ) ,$$

and the delay spread may satisfy the relationship,

$${δ}_{max}^{cyc} < cycic prefix length - {N}_{max} .$$

The delay spread may combine a channel delay and a cyclic delay, which may be measured (e.g., transparently) at a receiver. The delay spread may be a stored parameter at a receiver, and the delay spread may change based on application of one or more SD-CDD delay values. Thus, in some cases, the receiver may use an incorrect delay spread. Additionally, or alternatively, the delay spread may be measured in a transparent manner (e.g., prior to demodulation).

In some applications of transparent SD-CDD mechanisms, the UE 115 or the network entity 105 may apply a suboptimal channel estimation. For example, a root mean square (RMS) delay value may be measured (e.g., as 300 nanoseconds (ns)) at a transmitted (e.g., a network entity 105). A receiver (e.g., a UE 115) may subsequently apply a minimum mean square error (MMSE) channel estimation based on a frequency domain correlation (e.g., assuming a uniform delay profile with maximum (2*300) ns, regardless of whether SD-CDD is employed), which may result in communication errors at the receiver. To obtain more accurate delay information, SD-CDD values may be applied to one or more tracking reference signals (TRSs), which may increase reference signal overhead and radio traffic. If SD-CDD is not applied to the TRS(s), a delay value (e.g., a maximum delay value,

$${δ}_{max}^{cyc} )$$

may be constrained to relatively small values, which may limit transmission diversity gain.

In some cases, for uplink transmissions, the UE 115 may apply SD-CDD mechanisms to achieve a diversity gain, including for a single-port communication. For example, the UE 115 may use multiple antennas (e.g., multiple antenna elements of a same antenna array 230, or of different antenna arrays 230, or of sub-arrays thereof) for a single-port SD-CDD transmission. However, although the UE 115 may use multiple antennas, the network entity 105 may detect an uplink transmission as a communication of a single port. The UE 115 may determine one or more SD-CDD values based on a modulation coding scheme (MCS), a channel delay spread, a resource allocation (e.g., an allocated bandwidth for the uplink transmission), or any combination thereof. The network entity 105, however, may be unaware of whether the UE has applied a SD-CDD value for each uplink transmission (e.g., if the uplink transmission is scheduled using some downlink control information (DCI) formats, such as DCI 0_0). As such, the UE 115 and the network entity 105 may become misaligned, for example, in terms of power delay profile (PDP) received at the UE 115 (e.g., without SD-CDD) and PDP received at the network entity 105 (e.g., with SD-CDD). Such misalignment may also be applicable to other signal transmissions, such as physical uplink control channel (PUCCH) transmissions or physical uplink shared channel (PUSCH) transmissions. Because DMRS channel estimation may use the PDP for MMSE detection, such misalignment may degrade the channel estimation performance.

In some cases, the UE 115 may determine one or more SD-CDD values for transmissions using an assumed channel reciprocity between an uplink channel and a downlink channel (e.g., between the link 125-a and the link 125-b). However, the network entity 105 may have relatively more-accurate information associated with the uplink channel based on SRS channel estimation (e.g., based on measurement of one or more SRSs transmitted by the UE 115 and received by the network entity 105). Moreover, some communication schemes (e.g., FDD in sub-2 GHz for sixth generation (6G) systems) may refarm (e.g., reuse, repurpose) various frequency bands (e.g., from 4G LTE frequency bands), in which such channel reciprocity assumptions may not be applicable. For example, channel reciprocity properties may not be satisfactory in FDD pairing bands, which may be separated in the frequency domain by several hundred MHz.

In accordance with various aspects described herein, the network entity 105 may determine one or more delay values 215 (e.g., CDD values, SD-CDD values, uplink SD-CDD values). In some examples, the network entity 105 may output (e.g., transmit, indicate) and the delay values 215 using one or more messages (e.g., as a single message, as a two part signaling scheme). For example, a first delay value 215 (e.g., a first part of a SD-CDD value) may be indicated via a first type of control signaling (e.g., RRC signaling, signaling associated with establishing a communication link 125, static configuration signaling, semi-static configuration signaling), and a second delay value 215 (e.g., a second part of the SD-CDD value) may be indicated via second type of control signaling (e.g., DCI signaling, MAC-control element (MAC-CE) signaling, dynamic configuration signaling).

Such mechanisms may be utilized, for example, in scenarios of configured grant (CG) uplink transmission (e.g., with open-loop precoding, without transmitter precoding matrix indicator (TPMI) indication), in which the UE 115 may be configured (e.g., by a CG from the network entity 105) to autonomously transmit one or more transmissions 220 (e.g., at a given interval, using configured resources, via one or more beams 235 of the antenna array 230). In some examples, the UE 115 may generate signals to be transmitted via respective antenna ports of the antenna array 230. For example, to convey a transmission 220 (e.g., an uplink transmission, for a given data stream), the UE 115 may transit a first signal (e.g., for communicating data of the given data stream, without a delay) via a first antenna port (e.g., using a beam 235-a), and the UE 115 may transmit one or more second signals (e.g., for communicating the same data of the given data stream, delayed signals, delayed instances of the first signal) via one or more respective second antenna ports (e.g., in accordance with the one or more delay values 215, using a beam 235-b).

In some examples, the UE 115 may receive a configuration 225 (e.g., via a control message or some other signaling, via an RRC information element (IE) such as an SRS-ResourceSet IE) from the network entity 105. The configuration 225 may, in some examples, indicate (e.g., instruct, configure) the UE 115 to transmit one or more SRSs (e.g., or some other reference signal) associated with (e.g., used for) determination of the one or more delay values 215. The configuration 225 may include a parameter (e.g., a field) that indicates a usage of the SRSs transmitted by the UE 115. For example, the configuration may include a parameter indicating the UE 115 to transmit SRSs for usage (e.g., by the network entity 105) of determining one or more one or more delay values 215. Additionally, or alternatively, the network entity may utilize other SRSs (e.g., SRSs with a configured usage different than SD-CDD delay) to determine the one or more delay values 215.

Based on (e.g., in response to, as a result of) the reception of the SRS from the UE, the network entity 105 may determine the delay values 215 for the transmissions 220 (e.g., for CG UL transmission). When a delay value 215 is relatively small (e.g., less than a threshold), an effective channel may be relatively flatter (e.g., similar to a small delay-spread case). When a delay value 215 is relatively large (e.g., greater than a threshold), the effective channel may be more frequency-selective (e.g., similar to a large delay-spread case).

The network entity 105 may transmit one or more indications of one or more delay values 215 in accordance with various signaling mechanisms. In some examples, the network entity 105 may indicate delay values 215 via one or more messages (e.g., using two or more parts), which may include indicating one or more SD-CDD values by two parts (e.g., a default SD-CDD value and an adjusted SD-CDD value, a default SD-CDD value and a bounding value). For example, the network entity 105 may transmit a first indication (e.g., via RRC signaling, a ConfiguredGrantConfig IE, DCI signaling, or MAC-CE signaling) of a default delay value (e.g., a default SD-CDD value, T_{SD-CDD}, a static delay value). The network entity 105 may also transmit a second indication (e.g., via DCI signaling that carries an activating or overriding command of the CG uplink transmission, MAC-CE signaling, or other RRC signaling) of a delay offset (e.g., an adjusted SD-CDD value, Δ_{SD-CDD}, a dynamic delay value). Accordingly, the UE 115 may apply the delay offset to the default delay (e.g., T_{SD-CDD}+Δ_{SD-CDD}) to determine an SD-CDD value (e.g., or other delay value) to use for one or more transmissions 220 (e.g., a CG UL transmission).

Additionally, or alternatively, the network entity 105 may transmit a first indication (e.g., via RRC signaling, a ConfiguredGrantConfig IE, DCI signaling, or MAC-CE signaling) of an average delay value (e.g., a mean SD-CDD value, m_{sD-CDD}, a static value). The network entity 105 may also transmit a second indication (e.g., via DCI signaling that carries an activating or overriding command of the CG uplink transmission, MAC-CE signaling, or other RRC signaling) of a bounding value (e.g., range of SD-CDD value, r_{SD-CDD}, or a range percent of SD-CDD value, p_{SD-CDD}, a dynamic delay value). Accordingly, the UE 115 may determine an SD-CDD (e.g., or other delay value) that is within a range based on the average value and the bounding value (e.g., within m_{SD-CDD}−r_{SD-CDD} and m_{SD-CDD}+r_{SD-CDD}, or within m_{SD-CDD}·(1−p_{SD-CDD}) and m_{SD-CDD}·(1+p_{SD-CDD})) to use for transmissions 220 (e.g., a CG UL transmission).

In some examples, the UE 115 may be configured (e.g., preconfigured) with a set of delay offset values (e.g., Δ_{SD-CDD} values), a set of bounding values (e.g., r_{SD-CDD} values or p_{SD-CDD} values), or both (e.g., as defined by an industry standard). Additionally, or alternatively, such values may be configured together with the default delay value or the average delay value via the first indication (e.g., in the ConfiguredGrantConfig IE). In such examples, the second indication (e.g., the DCI message or MAC-CE message) may indicate an index of a delay offset, a bounding value, or some other delay value in the configured set.

Thus, by receiving various indications of one or more delay values 215 (e.g., and the configuration 225), the network entity 105 can support the UE 115 applying more accurate delays to signals of multi-port transmissions 220 (e.g., based on using uplink channel information determined at the network entity 105). For example, the UE 115 may apply a received delay value 215 to a transmission 220 via the beam 235-b (e.g., and may not apply a delay to a transmission 220 via the beam 235-a), which may improve communication reliability, improve adaptability to dynamic wireless channel conditions, and provide other benefits for the wireless communications system 200.

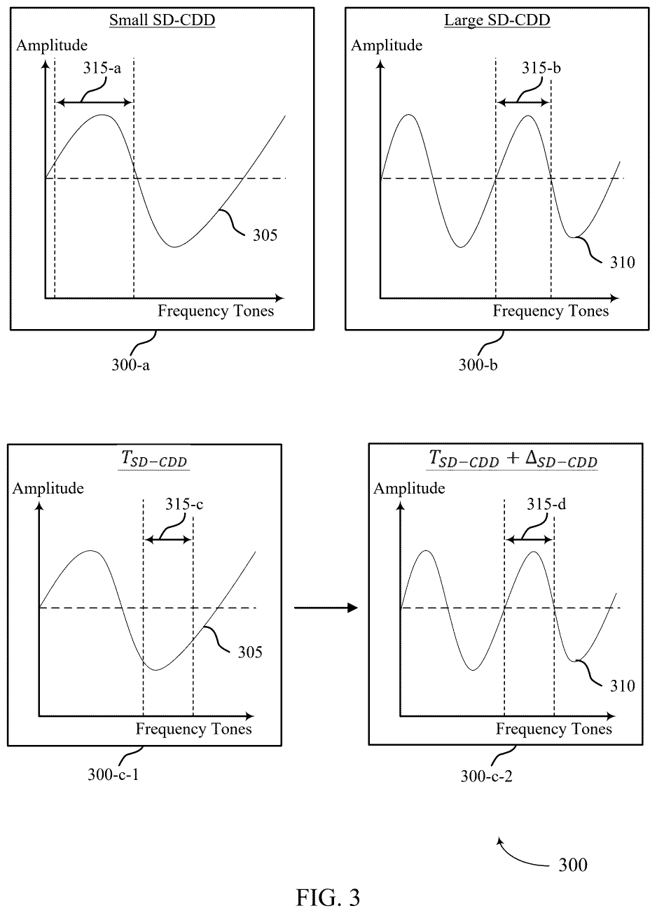

FIG. 3 shows examples of resource diagrams 300 that support network configuration of CDD for UE transmissions in accordance with one or more aspects of the present disclosure. Each resource diagram 300 may show a signal 305 or a signal 310 associated various amplitude and frequency resources along the vertical axes and horizontal axis, respectively. The signals 305 and 310 are provided as illustrative examples, and the aspects described herein may be applicable for signals different than the signal 305 and the signal 310 (e.g., associated with various waveforms, frequencies, period, amplitudes, and other properties). In some examples, a UE 115 or a network entity 105 may apply one or more delay values (e.g., delay values 215) to adjust a bandwidth 315 (e.g., a CG allocated bandwidth, and effective channel), which may improve communication quality and reliability. In some examples, the bandwidth 315 may be inversely proportional to a delay value (e.g., an SD-CDD delay value).

The resource diagram 300-a may show an example in which a relatively small SD-CDD value (e.g., below a threshold) is used (e.g., indicated, determined, selected) for communications. The small SD-CDD value may be associated with a bandwidth 315-a, which may be relatively large (e.g., spanning a quantity of frequency tones greater than a threshold). That is, due to the inverse proportionality relationship, small SD-CDD values may be beneficial for large bandwidth allocations (e.g., in scenarios where a relatively large quantity of frequency tones are associated with a relatively high signal amplitude). The resource diagram 300-b may show an example in which a relatively large SD-CDD value (e.g., above a threshold) is used (e.g., indicated, determined, selected) for communications. The large SD-CDD value may be associated with a bandwidth 315-b, which may be relatively small (e.g., spanning a quantity of frequency tones less than a threshold). That is, due to the inverse proportionality relationship, large SD-CDD values may be beneficial for small bandwidth allocations (e.g., in scenarios where a relatively small quantity of frequency tones are associated with a relatively high signal amplitude).

The resource diagrams 300-c may show an example in which adjusting an SD-CDD value, T_{SD-CDD}, may improve the bandwidth 315-c. For example (e.g., for a CG uplink transmission), an allocated bandwidth may remain the same. However, the channel may vary over time. Accordingly, the network entity 105 may use an adjusted SD-CDD value, Δ_{SD-CDD}, to adjust a previous configured SD-CDD value, T_{SD-CDD}, as T_{SD-CDD}+Δ_{SD-CDD}. That is, a UE 115 may be configured to communicate uplink transmissions in accordance with a first SD-CDD value, resulting in the bandwidth 315-c of the resource diagram 300-c-1. Based on a change in the wireless channel, the UE 115 may then receive an indication to communicate in accordance with a second SD-CDD value (e.g., an adjusted SD-CDD value), resulting in the bandwidth 315-d of the resource diagram 300-c-2. Thus, by signaling adjustments to the delay value (e.g., the SD-CDD, the delay values 215), devices of a wireless communications system (e.g., wireless communications system 100, wireless communications system 200) may improve communication quality based on improved allocations of bandwidth 315.

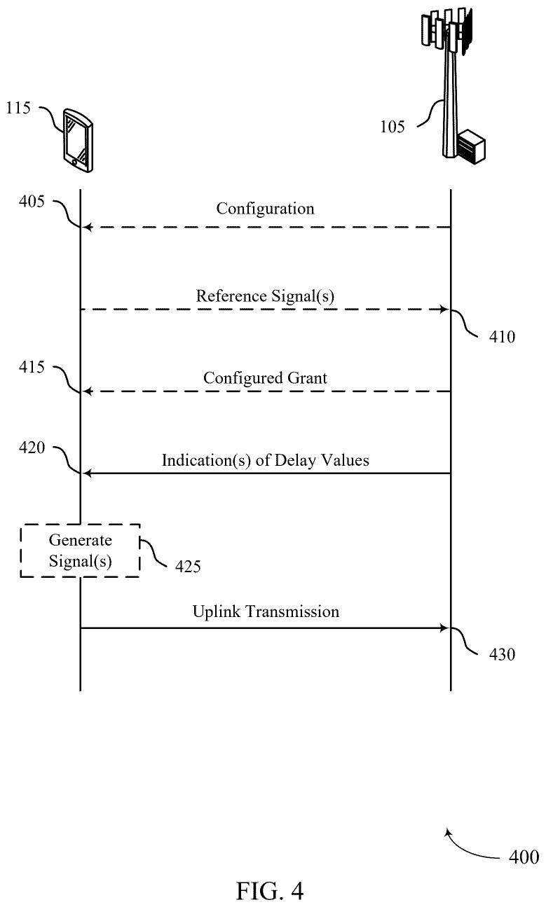

FIG. 4 shows an example of a process flow 400 that supports network configuration of CDD for UE transmissions in accordance with one or more aspects of the present disclosure. In some examples, the process flow 400 may implement aspects of the wireless communications system 100, the wireless communications system 200, and the resource diagrams 300. The UE 115 and the network entity 105 of the process flow 400 may be examples of corresponding devices herein, including with reference to FIGS. 1 through 3.

In the following description of the process flow 400, the operations between the UE 115 and the network entity 105 may be performed in a different order than the order shown, or other operations may be added or removed from the process flow 400. For example, some operations may also be left out of the process flow 400, or may be performed in different orders or at different times. Further, although some operations or signaling may be shown to occur at different times for discussion purposes, these operations may actually occur at the same time or overlapping times. Although the UE 115 and the network entity 105 are shown performing the operations of the process flow 400, some aspects of some operations may also be performed by one or more other wireless or network devices.

At 405, in some examples, the UE 115 may receive a configuration (e.g., a configuration 225) for SRS transmission, which may be output (e.g., transmitted) by the network entity 105. In some examples, the configuration may indicate that the SRSs are associated with (e.g., explicitly used for) a determination of one or more delay values (e.g., SD-CDD values).

At 410, in some examples, the UE 115 may transmit one or more reference signals, such as SRSs (e.g., in accordance with the configuration of 405), which may be obtained (e.g., received) by the network entity 105.

At 415, in some examples, the UE 115 may receive a CG that allocates a set of resources for uplink transmissions, which may be output by the network entity 105.

At 420, the UE 115 may receive one or more indications (e.g., a first indication, a second indication) of one or more delay values (e.g., delay values 215), which may be output (e.g., and determined) by the network entity 105. In some examples, receiving at least one indication of one or more delay values may be based on the UE 115 transmitting one or more SRSs at 410. Additionally, or alternatively, receiving at least one indication of one or more delay values may be based on receiving the CG. For example, one or more delay values may be specific to CG-based communications.

In some examples, each of the one or more delay values may be associated with a respective antenna port of a plurality of antenna ports (e.g., of an antenna array 230) at the UE 115. In some examples, the UE 115 may receive a first indication of a default delay (e.g., T_{SD-CDD}) associated with a respective antenna port (e.g., used for a delayed uplink transmission). The UE 115 may receive a second indication of a delay offset (e.g., Δ_{SD-CDD}) associated with the respective antenna port, and a respective delay (e.g., used for uplink transmission via the respective antenna port) corresponding to a sum of the default delay and the delay offset (e.g., T_{SD-CDD}+Δ_{SD-CDD}).

Additionally, or alternatively, the UE 115 may receive a first indication of an average delay (e.g., m_{SD-CDD}) associated with a respective antenna port. The UE 115 may also receive a second indication of a bounding value (e.g., r_{SD-CDD}, p_{SD-CDD}) associated with the respective antenna port, and a respective delay (e.g., used for uplink transmission via the respective antenna port) may be determined by the UE 115 to be within the bounding value of the average delay (e.g., between m_{SD-CDD}−r_{SD-CDD} and m_{SD-CDD}+r_{SD-CDD}, or between m_{SD-CDD}·(1−p_{SD-CDD}) and m_{SD-CDD}. (1+p_{SD-CDD})). Additionally, or alternatively, the UE 115 may receive an indication of an average delay associated with a respective antenna port, and the respective delay may be determined by the UE 115 to be within a configured range (e.g., based on a bounding value) of the average delay.

In some examples, receiving the one or more indications may include receiving a first indication of a first delay value (e.g., default delay, average delay) via a first type of control signaling (e.g., RRC signaling, DCI signaling, MAC-CE signaling) and receiving a second indication of a second delay value (e.g., delay offset, bounding value) via a second type of control signaling (e.g., DCI signaling, MAC-CE signaling, RRC signaling). In some examples, the first type of control signaling may be different than the second type of control signaling.

At 425, in some examples, the UE 115 may generate a first signal for transmission using a first antenna port of the plurality of antenna ports (e.g., which may not have an applied delay). The UE 115 may also generate one or more second signals (e.g., delayed signals, copies of the first signal but with an applied delay in accordance with the indication(s) at 420) for transmission using a respective second antenna port of the plurality of antenna ports. In some examples, the one or more second signals may be delayed by one or more SD-CDD values relative to the first signal. For example, the UE 115 may select one or more SD-CDD delay values that are within the indicated delay offset value of the indicated default delay value. Additionally, or alternatively, the UE 115 may select one or more SD-CDD delay values that are within the indicated bounding value of the indicated average delay. Additionally, or alternatively, the UE 115 may select one or more SD-CDD delay values that are within a configured range (e.g., an indicated range) of the indicated average delay.

At 430, the UE 115 may transmit an uplink transmission (e.g., a transmission 220), which may be obtained by the network entity 105. In some examples, the UE 115 may transmit the uplink transmission based on generating the first signal for transmission using the first antenna port of the plurality of antenna ports and generating the one or more second signals for transmission using the respective second antenna port of the plurality of antenna ports. In some examples, each of the one or more second signals may have a respective delay relative to the first signal in accordance with the one or more delay values. In some examples, transmitting the uplink transmission may be based on receiving various indications such as the first indication and the second indication (e.g., via respective types of control signaling).

In some examples, one or more operations of the process flow 400 may be repeated by the UE 115 or the network entity 105 (e.g., to adjust one or more delay values). For example, the UE 115 may receive one or more second indications of one or more second delay values output by the network entity 105. In some examples, each of the one or more second delay values may be associated with a respective antenna port of the plurality of antenna ports, and the second delay values may be different than the previously-indicated delay values. The UE 115 may transmit a second uplink transmission, which may be obtained by the network entity 105, based on generating a third signal for transmission using the first antenna port and generating one or more fourth signals for transmission using a respective second antenna port of the plurality of antenna ports. In some examples, each of the one or more fourth signals may have a respective second delay relative to the third signal in accordance with the one or more second delay values.

Thus, by applying various aspects of the process flow 400, the UE 115 and the network entity 105 may utilize more accurate delay values (e.g., SD-CDD values) for uplink transmissions (e.g., CG uplink transmissions). For example, the network entity 105 may utilize uplink channel information to determine and indicate one or more delay value to the UE 115. Additionally, the UE 115 may be enabled to dynamically adjust one or more delay values used for CG transmissions, which may improve communication reliability, improve adaptability to dynamic wireless channel conditions, and provide other benefits for a wireless communications system.

Although aspects of these techniques are described in the context of CDD values for uplink transmissions, the techniques may also be implemented for sidelink transmissions, among others. For example, a first UE 115 may be configured to receive indications of one or more delay values from a network entity 105 or a second UE 115 (e.g., based on the second UE 115 receiving SRS transmissions from different ports of the first UE 115), and to transmit a sidelink transmission based at least in part on generating respective signals for transmission using respective antenna ports in accordance with the one or more delay values.

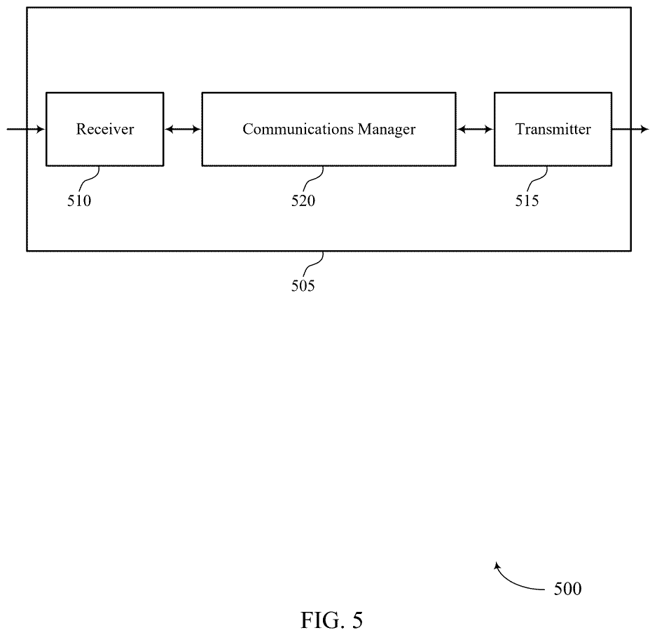

FIG. 5 shows a block diagram 500 of a device 505 that supports network configuration of CDD for UE transmissions in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to network configuration of CDD for UE transmissions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to network configuration of CDD for UE transmissions). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of network configuration of CDD for UE transmissions as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, at a UE, one or more indications of one or more delay values, each of the one or more delay values associated with a respective antenna port of a set of multiple antenna ports. The communications manager 520 is capable of, configured to, or operable to support a means for transmitting, from the UE, an uplink transmission based on generating a first signal for transmission using a first antenna port of the set of multiple antenna ports and generating one or more second signals for transmission using a respective second antenna port of the set of multiple antenna ports, each of the one or more second signals having a respective delay relative to the first signal in accordance with the one or more delay values.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources, among other benefits. For example, including a communications manager 520 may allow a UE to receive indications of delay values to be used for multi-port transmissions rather than independently determine the delay values, which may enable to the UE to reduce processing and reduce power consumption.

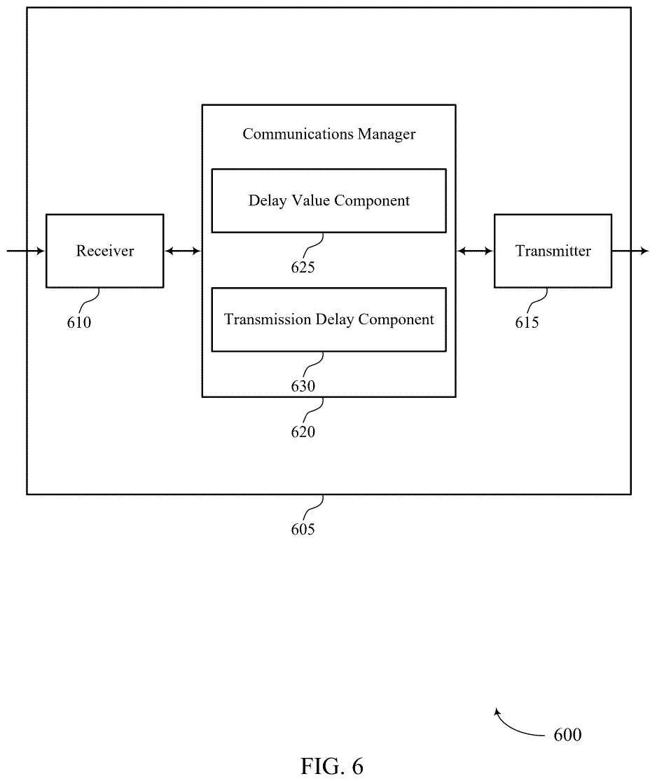

FIG. 6 shows a block diagram 600 of a device 605 that supports network configuration of CDD for UE transmissions in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to network configuration of CDD for UE transmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to network configuration of CDD for UE transmissions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of network configuration of CDD for UE transmissions as described herein. For example, the communications manager 620 may include a delay value component 625 a transmission delay component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The delay value component 625 is capable of, configured to, or operable to support a means for receiving, at a UE, one or more indications of one or more delay values, each of the one or more delay values associated with a respective antenna port of a set of multiple antenna ports. The transmission delay component 630 is capable of, configured to, or operable to support a means for transmitting, from the UE, an uplink transmission based on generating a first signal for transmission using a first antenna port of the set of multiple antenna ports and generating one or more second signals for transmission using a respective second antenna port of the set of multiple antenna ports, each of the one or more second signals having a respective delay relative to the first signal in accordance with the one or more delay values.

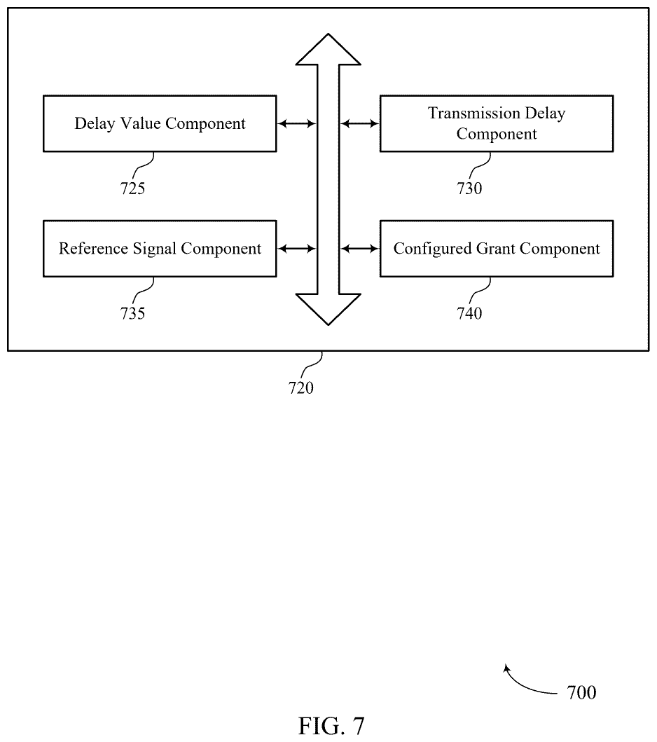

FIG. 7 shows a block diagram 700 of a communications manager 720 that supports network configuration of CDD for UE transmissions in accordance with one or more aspects of the present disclosure. The communications manager 720 may be an example of aspects of a communications manager 520, a communications manager 620, or both, as described herein. The communications manager 720, or various components thereof, may be an example of means for performing various aspects of network configuration of CDD for UE transmissions as described herein. For example, the communications manager 720 may include a delay value component 725, a transmission delay component 730, a reference signal component 735, a configured grant component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The delay value component 725 is capable of, configured to, or operable to support a means for receiving, at a UE, one or more indications of one or more delay values, each of the one or more delay values associated with a respective antenna port of a set of multiple antenna ports. The transmission delay component 730 is capable of, configured to, or operable to support a means for transmitting, from the UE, an uplink transmission based on generating a first signal for transmission using a first antenna port of the set of multiple antenna ports and generating one or more second signals for transmission using a respective second antenna port of the set of multiple antenna ports, each of the one or more second signals having a respective delay relative to the first signal in accordance with the one or more delay values.

In some examples, to support receiving the one or more indications, the delay value component 725 is capable of, configured to, or operable to support a means for receiving a first indication of a default delay associated with the respective second antenna port. In some examples, to support receiving the one or more indications, the delay value component 725 is capable of, configured to, or operable to support a means for receiving a second indication of a delay offset associated with the respective second antenna port, the respective delay corresponding to a sum of the default delay and the delay offset.

In some examples, to support receiving the one or more indications, the delay value component 725 is capable of, configured to, or operable to support a means for receiving a first indication of an average delay associated with the respective second antenna port. In some examples, to support receiving the one or more indications, the delay value component 725 is capable of, configured to, or operable to support a means for receiving a second indication of a bounding value associated with the respective second antenna port, the respective delay being determined by the UE to be within the bounding value of the average delay.

In some examples, to support receiving the one or more indications, the delay value component 725 is capable of, configured to, or operable to support a means for receiving an indication of an average delay associated with the respective second antenna port, the respective delay being determined by the UE to be within a configured range of the average delay.

In some examples, the reference signal component 735 is capable of, configured to, or operable to support a means for receiving a configuration for sounding reference signal transmission. In some examples, the reference signal component 735 is capable of, configured to, or operable to support a means for transmitting one or more sounding reference signals in accordance with the configuration, where receiving the one or more indications of the one or more delay values is based on transmitting the one or more sounding reference signals in accordance with the configuration.

In some examples, receiving the one or more indications includes receiving a first indication of a first delay value via a first type of control signaling and receiving a second indication of a second delay value via a second type of control signaling. In some examples, transmitting the uplink transmission is based on receiving the first indication and the second indication.

In some examples, the configured grant component 740 is capable of, configured to, or operable to support a means for receiving a configured grant that allocates a set of resources for uplink transmissions, where receiving at least one of the one or more indications is based on receiving the configured grant.

In some examples, the delay value component 725 is capable of, configured to, or operable to support a means for receiving, at the UE, one or more second indications of one or more second delay values, each of the one or more second delay values associated with a respective antenna port of the set of multiple antenna ports. In some examples, the transmission delay component 730 is capable of, configured to, or operable to support a means for transmitting, from the UE, a second uplink transmission based on generating a third signal for transmission using the first antenna port and generating one or more fourth signals for transmission using a respective second antenna port of the set of multiple antenna ports, each of the one or more fourth signals having a respective second delay relative to the third signal in accordance with the one or more second delay values.

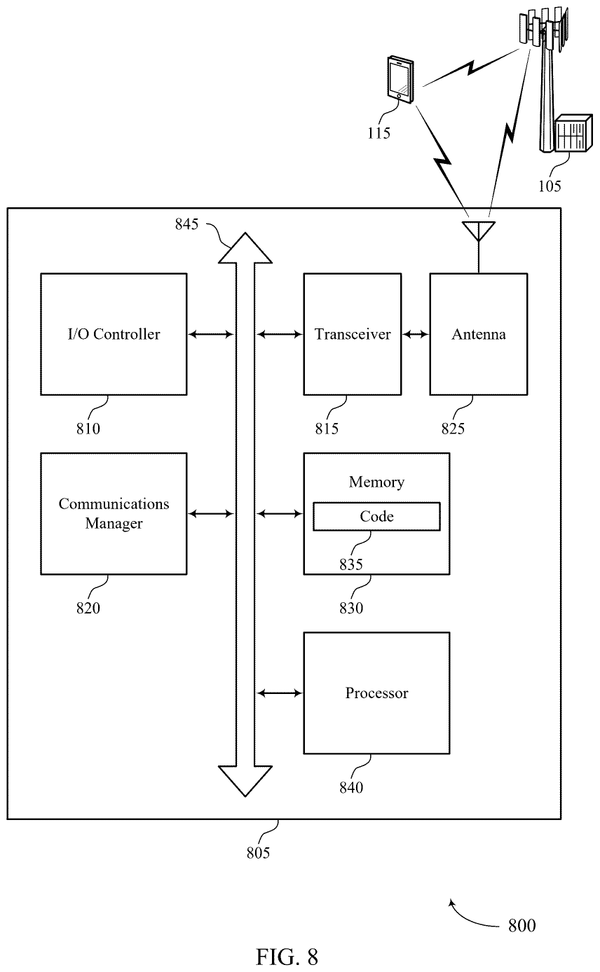

FIG. 8 shows a diagram of a system 800 including a device 805 that supports network configuration of CDD for UE transmissions in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting network configuration of CDD for UE transmissions). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, at the device 805, one or more indications of one or more delay values, each of the one or more delay values associated with a respective antenna port of a set of multiple antenna ports. The communications manager 820 is capable of, configured to, or operable to support a means for transmitting, from the device 805, an uplink transmission based on generating a first signal for transmission using a first antenna port of the set of multiple antenna ports and generating one or more second signals for transmission using a respective second antenna port of the set of multiple antenna ports, each of the one or more second signals having a respective delay relative to the first signal in accordance with the one or more delay values.

By including or configuring the communications manager 820 in accordance with examples as described herein, the device 805 may support techniques for improved communication reliability, improved user experience related to reduced processing, reduced power consumption, more efficient utilization of communication resources, and improved coordination between devices, among other benefits. For example, the device 805 may be enabled to receive indications from a network entity 105 (e.g., which may have additional information relevant to an uplink channel) of suggested delay values, which may increase coordination between the UE and the network entity.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of network configuration of CDD for UE transmissions as described herein, or the at least one processor 840 and the at least one memory 830 may be otherwise configured to, individually or collectively, perform or support such operations.

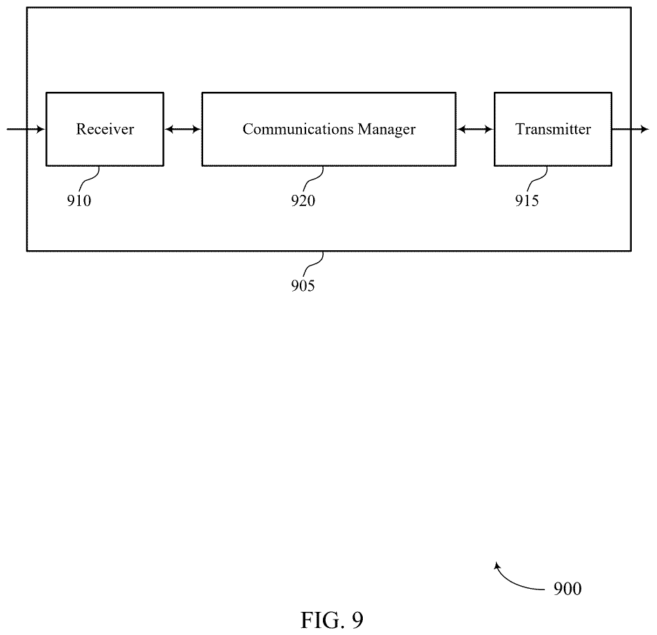

FIG. 9 shows a block diagram 900 of a device 905 that supports network configuration of CDD for UE transmissions in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of network configuration of CDD for UE transmissions as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting, from a network entity, one or more indications of one or more delay values for a UE, each of the one or more delay values associated with a respective antenna port of a set of multiple antenna ports. The communications manager 920 is capable of, configured to, or operable to support a means for obtaining, at the network entity, an uplink transmission from the UE based on outputting the one or more indications of the one or more delay values for the UE.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources, among other benefits. For example, by including a communications manager 920, a network entity 105 may be configured to output delay values to a UE 115 in accordance with uplink channel information, thus enabling more efficient utilization of communications resource by the network entity 105 and the UE 115.

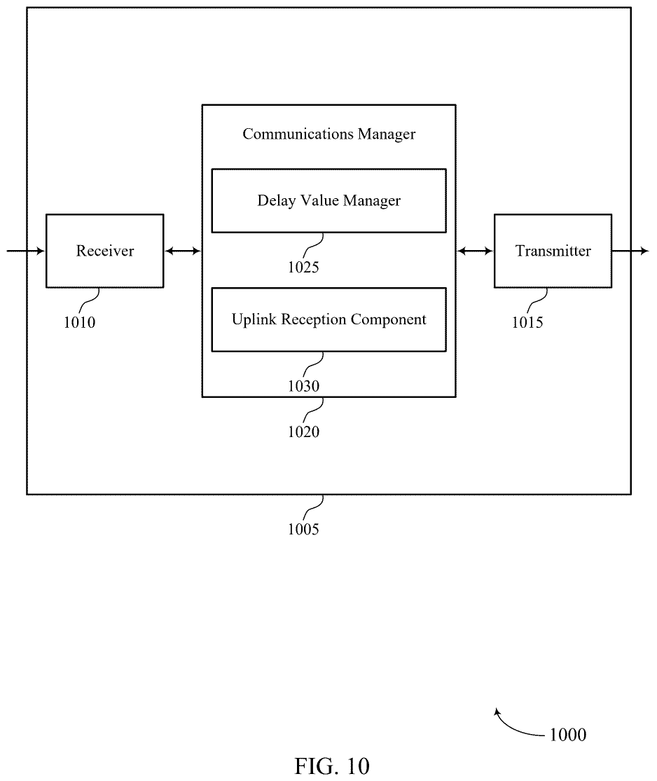

FIG. 10 shows a block diagram 1000 of a device 1005 that supports network configuration of CDD for UE transmissions in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of network configuration of CDD for UE transmissions as described herein. For example, the communications manager 1020 may include a delay value manager 1025 an uplink reception component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The delay value manager 1025 is capable of, configured to, or operable to support a means for outputting, from a network entity, one or more indications of one or more delay values for a UE, each of the one or more delay values associated with a respective antenna port of a set of multiple antenna ports. The uplink reception component 1030 is capable of, configured to, or operable to support a means for obtaining, at the network entity, an uplink transmission from the UE based on outputting the one or more indications of the one or more delay values for the UE.

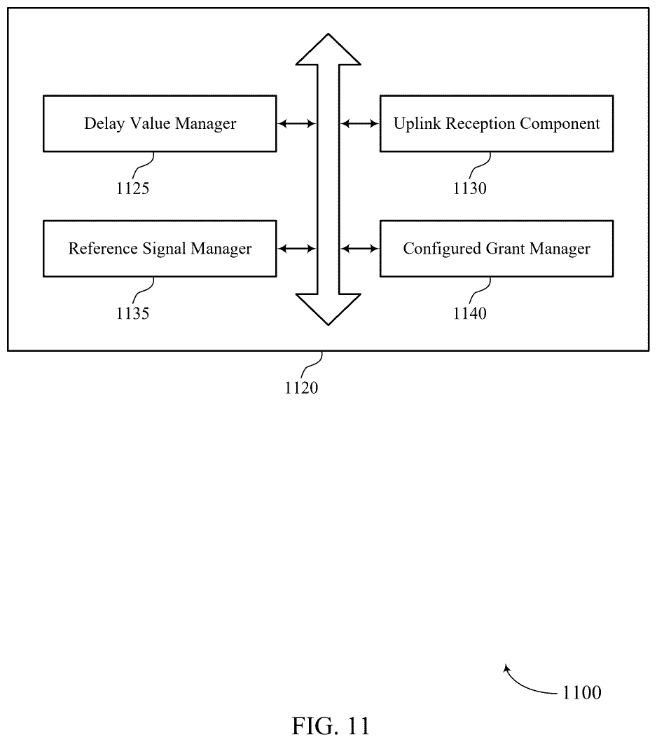

FIG. 11 shows a block diagram 1100 of a communications manager 1120 that supports network configuration of CDD for UE transmissions in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of network configuration of CDD for UE transmissions as described herein. For example, the communications manager 1120 may include a delay value manager 1125, an uplink reception component 1130, a reference signal manager 1135, a configured grant manager 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The delay value manager 1125 is capable of, configured to, or operable to support a means for outputting, from a network entity, one or more indications of one or more delay values for a UE, each of the one or more delay values associated with a respective antenna port of a set of multiple antenna ports. The uplink reception component 1130 is capable of, configured to, or operable to support a means for obtaining, at the network entity, an uplink transmission from the UE based on outputting the one or more indications of the one or more delay values for the UE.

In some examples, the uplink transmission is based on a first signal for transmission using a first antenna port of the set of multiple antenna ports and one or more second signals for transmission using a respective second antenna port of the set of multiple antenna ports, each of the one or more second signals having a respective delay relative to the first signal in accordance with the one or more delay values.

In some examples, to support outputting the one or more indications, the delay value manager 1125 is capable of, configured to, or operable to support a means for outputting a first indication of a default delay associated with a respective antenna port. In some examples, to support outputting the one or more indications, the delay value manager 1125 is capable of, configured to, or operable to support a means for outputting a second indication of a delay offset associated with the respective antenna port.

In some examples, to support outputting the one or more indications, the delay value manager 1125 is capable of, configured to, or operable to support a means for outputting a first indication of an average delay associated with a respective antenna port. In some examples, to support outputting the one or more indications, the delay value manager 1125 is capable of, configured to, or operable to support a means for outputting a second indication of a bounding value associated with the respective antenna port.

In some examples, to support outputting the one or more indications, the delay value manager 1125 is capable of, configured to, or operable to support a means for outputting an indication of an average delay associated with a respective antenna port.

In some examples, the reference signal manager 1135 is capable of, configured to, or operable to support a means for outputting a configuration for sounding reference signal transmission. In some examples, the reference signal manager 1135 is capable of, configured to, or operable to support a means for obtaining one or more sounding reference signals in response to outputting the configuration, where outputting the one or more indications of the one or more delay values is based on obtaining the one or more sounding reference signals.

In some examples, to support outputting the one or more indications, the delay value manager 1125 is capable of, configured to, or operable to support a means for outputting a first indication of a first cyclic delay value via a first type of control signaling. In some examples, to support outputting the one or more indications, the delay value manager 1125 is capable of, configured to, or operable to support a means for outputting a second indication of a second cyclic delay value via a second type of control signaling.

In some examples, the configured grant manager 1140 is capable of, configured to, or operable to support a means for outputting a configured grant that allocates a set of resources for uplink transmissions, where outputting at least one of the one or more indications is based on receiving the configured grant.

In some examples, the delay value manager 1125 is capable of, configured to, or operable to support a means for outputting, from the network entity, one or more second indications of one or more second delay values for the user equipment, each of the one or more second delay values associated with a respective antenna port of the set of multiple antenna ports. In some examples, the uplink reception component 1130 is capable of, configured to, or operable to support a means for obtaining, at the network entity, a second uplink transmission from the UE based on outputting the one or more second indications of the one or more second delay values for the UE.

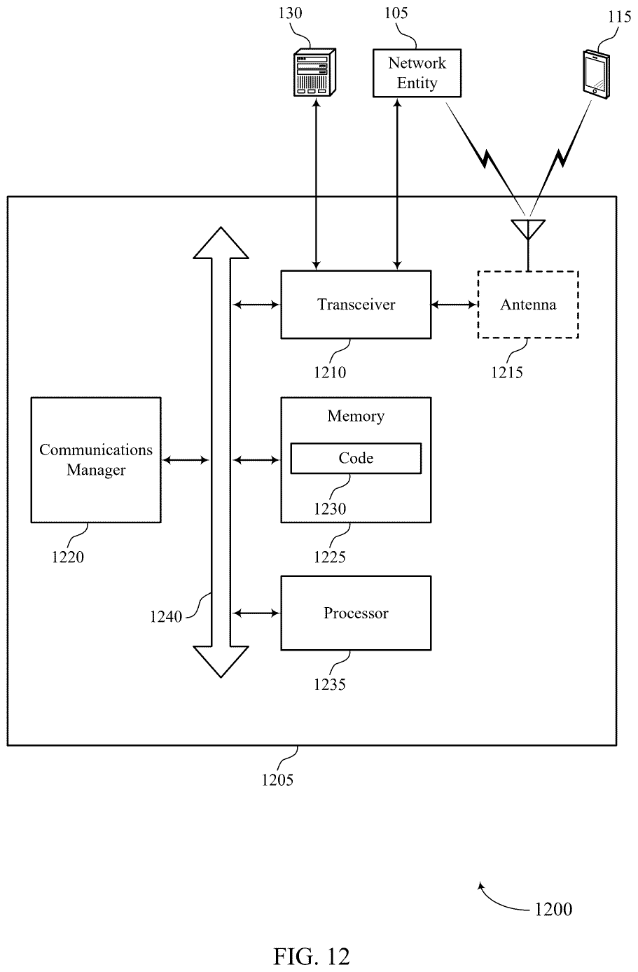

FIG. 12 shows a diagram of a system 1200 including a device 1205 that supports network configuration of CDD for UE transmissions in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting network configuration of CDD for UE transmissions). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting, from the device 1205, one or more indications of one or more delay values for a UE, each of the one or more delay values associated with a respective antenna port of a set of multiple antenna ports. The communications manager 1220 is capable of, configured to, or operable to support a means for obtaining, at the device 1205, an uplink transmission from the UE based on outputting the one or more indications of the one or more delay values for the UE.

By including or configuring the communications manager 1220 in accordance with examples as described herein, the device 1205 may support techniques for improved communication reliability, more efficient utilization of communication resources, improved coordination between devices, and improved utilization of processing capability, among other benefits. For example, the device 1205 may be enabled to output indicated delay values to a UE 115, which may increase coordination between the UE 115 and the device 1205. Further, the device 1205 may output the delay values in accordance with additional channel information, which may provide more efficient utilization (e.g., allocation) of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of network configuration of CDD for UE transmissions as described herein, or the at least one processor 1235 and the at least one memory 1225 may be otherwise configured to, individually or collectively, perform or support such operations.

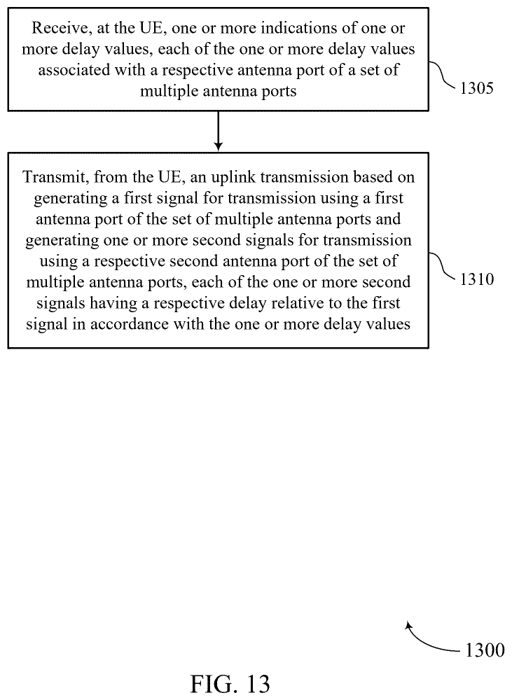

FIG. 13 shows a flowchart illustrating a method 1300 that supports network configuration of CDD for UE transmissions in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, at the UE, one or more indications of one or more delay values, each of the one or more delay values associated with a respective antenna port of a set of multiple antenna ports. The operations of 1305 may be performed in accordance with examples as disclosed herein. In some examples, aspects of the operations of 1305 may be performed by a delay value component 725 as described with reference to FIG. 7.

At 1310, the method may include transmitting, from the UE, an uplink transmission based on generating a first signal for transmission using a first antenna port of the set of multiple antenna ports and generating one or more second signals for transmission using a respective second antenna port of the set of multiple antenna ports, each of the one or more second signals having a respective delay relative to the first signal in accordance with the one or more delay values. The operations of 1310 may be performed in accordance with examples as disclosed herein. In some examples, aspects of the operations of 1310 may be performed by a transmission delay component 730 as described with reference to FIG. 7.

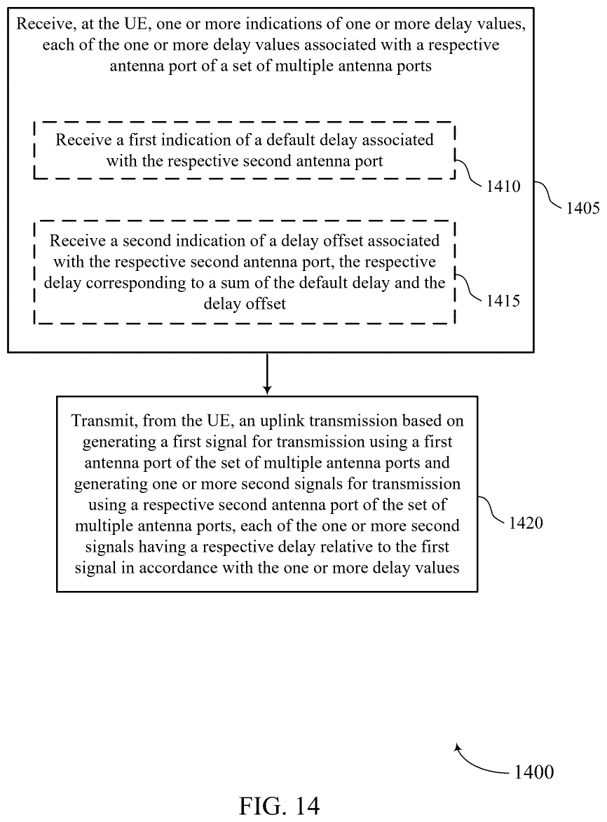

FIG. 14 shows a flowchart illustrating a method 1400 that supports network configuration of CDD for UE transmissions in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, at the UE, one or more indications of one or more delay values, each of the one or more delay values associated with a respective antenna port of a set of multiple antenna ports. For example, at 1410, the method may include receiving a first indication of a default delay associated with the respective second antenna port and, at 1415 the method may include receiving a second indication of a delay offset associated with the respective second antenna port, the respective delay corresponding to a sum of the default delay and the delay offset. The operations of 1405 may be performed in accordance with examples as disclosed herein. In some examples, aspects of the operations of 1405 may be performed by a delay value component 725 as described with reference to FIG. 7.

At 1420, the method may include transmitting, from the UE, an uplink transmission based on generating a first signal for transmission using a first antenna port of the set of multiple antenna ports and generating one or more second signals for transmission using a respective second antenna port of the set of multiple antenna ports, each of the one or more second signals having a respective delay relative to the first signal in accordance with the one or more delay values. The operations of 1420 may be performed in accordance with examples as disclosed herein. In some examples, aspects of the operations of 1420 may be performed by a transmission delay component 730 as described with reference to FIG. 7.

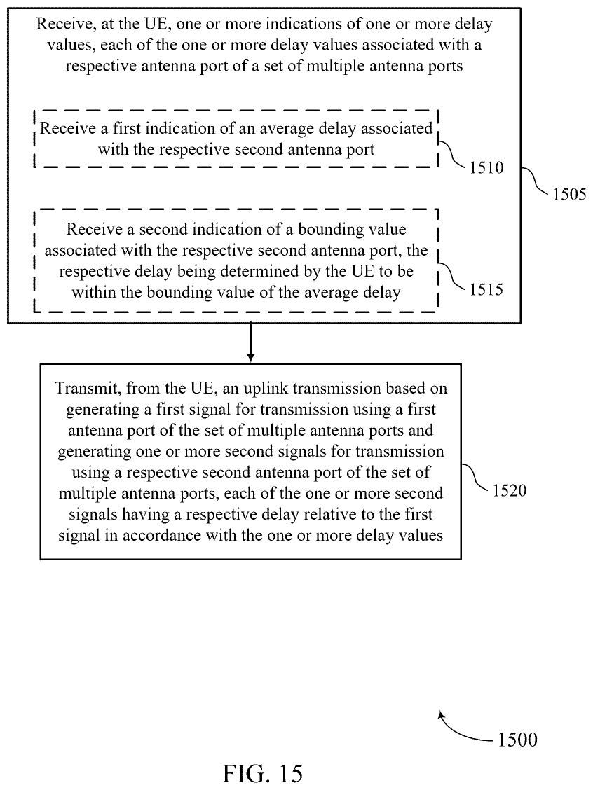

FIG. 15 shows a flowchart illustrating a method 1500 that supports network configuration of CDD for UE transmissions in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving, at the UE, one or more indications of one or more delay values, each of the one or more delay values associated with a respective antenna port of a set of multiple antenna ports. For example, at 1510, the method may include receiving a first indication of an average delay associated with the respective second antenna port and, at 1515, the method may include receiving a second indication of a bounding value associated with the respective second antenna port, the respective delay being determined by the UE to be within the bounding value of the average delay. The operations of 1505 may be performed in accordance with examples as disclosed herein. In some examples, aspects of the operations of 1505 may be performed by a delay value component 725 as described with reference to FIG. 7.

At 1520, the method may include transmitting, from the UE, an uplink transmission based on generating a first signal for transmission using a first antenna port of the set of multiple antenna ports and generating one or more second signals for transmission using a respective second antenna port of the set of multiple antenna ports, each of the one or more second signals having a respective delay relative to the first signal in accordance with the one or more delay values. The operations of 1520 may be performed in accordance with examples as disclosed herein. In some examples, aspects of the operations of 1520 may be performed by a transmission delay component 730 as described with reference to FIG. 7.

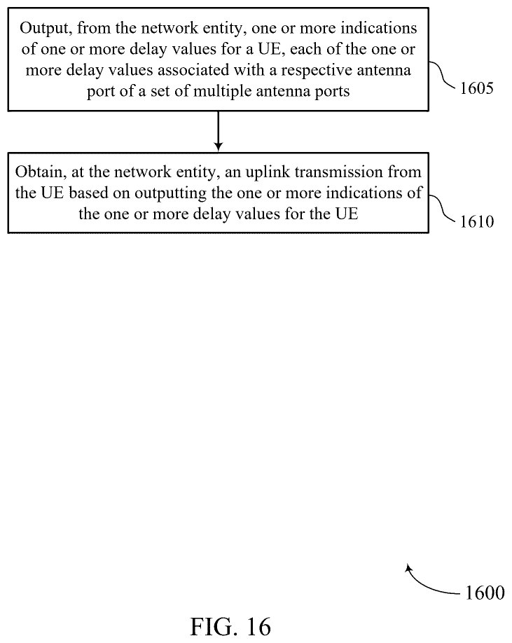

FIG. 16 shows a flowchart illustrating a method 1600 that supports network configuration of CDD for UE transmissions in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting, from the network entity, one or more indications of one or more delay values for a UE, each of the one or more delay values associated with a respective antenna port of a set of multiple antenna ports. The operations of 1605 may be performed in accordance with examples as disclosed herein. In some examples, aspects of the operations of 1605 may be performed by a delay value manager 1125 as described with reference to FIG. 11.

At 1610, the method may include obtaining, at the network entity, an uplink transmission from the UE based on outputting the one or more indications of the one or more delay values for the UE. The operations of 1610 may be performed in accordance with examples as disclosed herein. In some examples, aspects of the operations of 1610 may be performed by an uplink reception component 1130 as described with reference to FIG. 11.

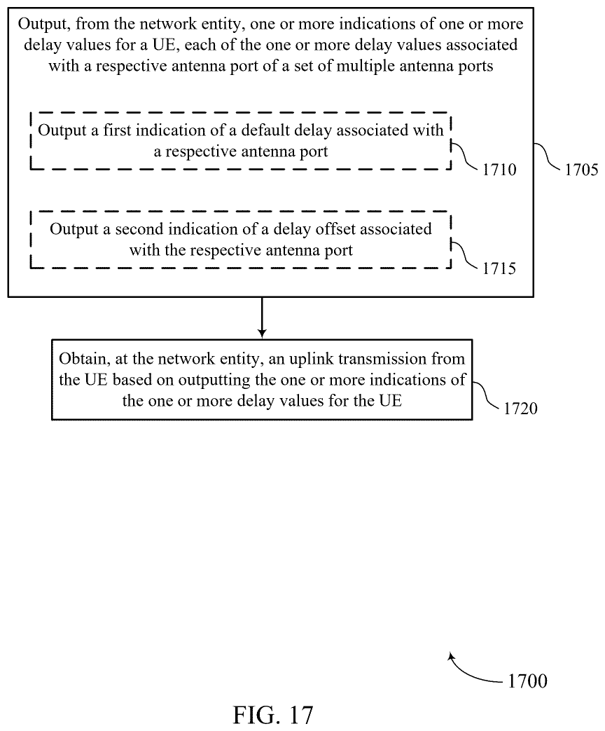

FIG. 17 shows a flowchart illustrating a method 1700 that supports network configuration of CDD for UE transmissions in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include outputting, from the network entity, one or more indications of one or more delay values for a UE, each of the one or more delay values associated with a respective antenna port of a set of multiple antenna ports. For example, at 1710, the method may include outputting a first indication of a default delay associated with a respective antenna port and, at 1715, the method may include outputting a second indication of a delay offset associated with the respective antenna port. The operations of 1705 may be performed in accordance with examples as disclosed herein. In some examples, aspects of the operations of 1705 may be performed by a delay value manager 1125 as described with reference to FIG. 11.

At 1720, the method may include obtaining, at the network entity, an uplink transmission from the UE based on outputting the one or more indications of the one or more delay values for the UE. The operations of 1720 may be performed in accordance with examples as disclosed herein. In some examples, aspects of the operations of 1720 may be performed by an uplink reception component 1130 as described with reference to FIG. 11.

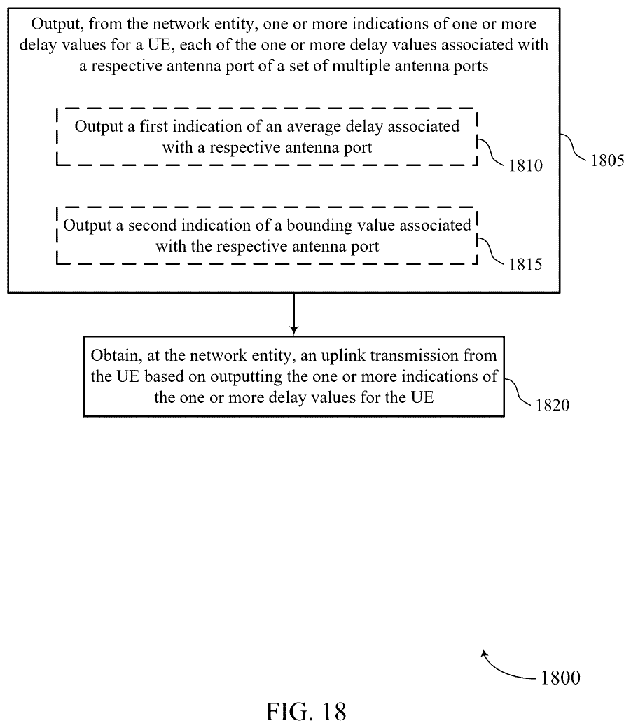

FIG. 18 shows a flowchart illustrating a method 1800 that supports network configuration of CDD for UE transmissions in accordance with one or more aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include outputting, from the network entity, one or more indications of one or more delay values for a UE, each of the one or more delay values associated with a respective antenna port of a set of multiple antenna ports. For example, at 1810, the method may include outputting a first indication of an average delay associated with a respective antenna port and, at 1815, the method may include outputting a second indication of a bounding value associated with the respective antenna port. The operations of 1805 may be performed in accordance with examples as disclosed herein. In some examples, aspects of the operations of 1805 may be performed by a delay value manager 1125 as described with reference to FIG. 11.

At 1820, the method may include obtaining, at the network entity, an uplink transmission from the UE based on outputting the one or more indications of the one or more delay values for the UE. The operations of 1820 may be performed in accordance with examples as disclosed herein. In some examples, aspects of the operations of 1820 may be performed by an uplink reception component 1130 as described with reference to FIG. 11.

The following provides an overview of aspects of the present disclosure:

Aspect 1: A method for wireless communications at a UE, comprising: receiving, at the UE, one or more indications of one or more delay values, each of the one or more delay values associated with a respective antenna port of a plurality of antenna ports; and transmitting, from the UE, an uplink transmission based at least in part on generating a first signal for transmission using a first antenna port of the plurality of antenna ports and generating one or more second signals for transmission using a respective second antenna port of the plurality of antenna ports, each of the one or more second signals having a respective delay relative to the first signal in accordance with the one or more delay values.

Aspect 2: The method of aspect 1, wherein receiving the one or more indications comprises: receiving a first indication of a default delay associated with the respective second antenna port; and receiving a second indication of a delay offset associated with the respective second antenna port, the respective delay corresponding to a sum of the default delay and the delay offset.

Aspect 3: The method of any of aspects 1 through 2, wherein receiving the one or more indications comprises: receiving a first indication of an average delay associated with the respective second antenna port; and receiving a second indication of a bounding value associated with the respective second antenna port, the respective delay being determined by the UE to be within the bounding value of the average delay.

Aspect 4: The method of any of aspects 1 through 3, wherein receiving the one or more indications comprises: receiving an indication of an average delay associated with the respective second antenna port, the respective delay being determined by the UE to be within a configured range of the average delay.

Aspect 5: The method of any of aspects 1 through 4, further comprising: receiving a configuration for SRS transmission; and transmitting one or more SRSs in accordance with the configuration, wherein receiving the one or more indications of the one or more delay values is based at least in part on transmitting the one or more SRSs in accordance with the configuration.

Aspect 6: The method of any of aspects 1 through 5, wherein receiving the one or more indications comprises receiving a first indication of a first delay value via a first type of control signaling and receiving a second indication of a second delay value via a second type of control signaling, and transmitting the uplink transmission is based at least in part on receiving the first indication and the second indication.

Aspect 7: The method of any of aspects 1 through 6, further comprising: receiving a CG that allocates a set of resources for uplink transmissions, wherein receiving at least one of the one or more indications is based at least in part on receiving the CG.

Aspect 8: The method of any of aspects 1 through 7, further comprising: receiving, at the UE, one or more second indications of one or more second delay values, each of the one or more second delay values associated with a respective antenna port of the plurality of antenna ports; and transmitting, from the UE, a second uplink transmission based at least in part on generating a third signal for transmission using the first antenna port and generating one or more fourth signals for transmission using a respective second antenna port of the plurality of antenna ports, each of the one or more fourth signals having a respective second delay relative to the third signal in accordance with the one or more second delay values.

Aspect 9: A method for wireless communications by a network entity, comprising: outputting, from the network entity, one or more indications of one or more delay values for a UE, each of the one or more delay values associated with a respective antenna port of a plurality of antenna ports; and obtaining, at the network entity, an uplink transmission from the UE based at least in part on outputting the one or more indications of the one or more delay values for the UE.

Aspect 10: The method of aspect 9, wherein the uplink transmission is based at least in part on a first signal for transmission using a first antenna port of the plurality of antenna ports and one or more second signals for transmission using a respective second antenna port of the plurality of antenna ports, each of the one or more second signals having a respective delay relative to the first signal in accordance with the one or more delay values.

Aspect 11: The method of any of aspects 9 through 10, wherein outputting the one or more indications comprises: outputting a first indication of a default delay associated with a respective antenna port; and outputting a second indication of a delay offset associated with the respective antenna port.

Aspect 12: The method of any of aspects 9 through 11, wherein outputting the one or more indications comprises: outputting a first indication of an average delay associated with a respective antenna port; and outputting a second indication of a bounding value associated with the respective antenna port.

Aspect 13: The method of any of aspects 9 through 12, wherein outputting the one or more indications comprises: outputting an indication of an average delay associated with a respective antenna port.

Aspect 14: The method of any of aspects 9 through 13, further comprising: outputting a configuration for SRS transmission; and obtaining one or more SRSs in response to outputting the configuration, wherein outputting the one or more indications of the one or more delay values is based at least in part on obtaining the one or more SRSs.

Aspect 15: The method of any of aspects 9 through 14, wherein outputting the one or more indications comprises: outputting a first indication of a first cyclic delay value via a first type of control signaling; and outputting a second indication of a second cyclic delay value via a second type of control signaling.

Aspect 16: The method of any of aspects 9 through 15, further comprising: outputting a CG that allocates a set of resources for uplink transmissions, wherein outputting at least one of the one or more indications is based at least in part on receiving the CG.

Aspect 17: The method of any of aspects 9 through 16, further comprising: outputting, from the network entity, one or more second indications of one or more second delay values for the user equipment, each of the one or more second delay values associated with a respective antenna port of the plurality of antenna ports; and obtaining, at the network entity, a second uplink transmission from the UE based at least in part on outputting the one or more second indications of the one or more second delay values for the UE.

Aspect 18: A UE for wireless communications, comprising one or more memories storing processor-executable code, and one or more processors coupled with the one or more memories and individually or collectively operable to execute the code to cause the UE to perform a method of any of aspects 1 through 8.

Aspect 19: A UE for wireless communications, comprising at least one means for performing a method of any of aspects 1 through 8.

Aspect 20: A non-transitory computer-readable medium storing code for wireless communications, the code comprising instructions executable by one or more processors to perform a method of any of aspects 1 through 8.

Aspect 21: A network entity for wireless communications, comprising one or more memories storing processor-executable code, and one or more processors coupled with the one or more memories and individually or collectively operable to execute the code to cause the network entity to perform a method of any of aspects 9 through 17.

Aspect 22: A network entity for wireless communications, comprising at least one means for performing a method of any of aspects 9 through 17.

Aspect 23: A non-transitory computer-readable medium storing code for wireless communications, the code comprising instructions executable by one or more processors to perform a method of any of aspects 9 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more indications of one or more delay values, each of the one or more delay values associated with a respective antenna port of a plurality of antenna ports; and
transmit an uplink transmission based at least in part on generation of a first signal for transmission using a first antenna port of the plurality of antenna ports and generation of one or more second signals for transmission using a respective second antenna port of the plurality of antenna ports, each of the one or more second signals having a respective delay relative to the first signal in accordance with the one or more delay values.

2. The UE of claim 1, wherein, to receive the one or more indications, the one or more processors are individually or collectively operable to execute the code to cause the UE to:
receive a first indication of a default delay associated with the respective second antenna port; and
receive a second indication of a delay offset associated with the respective second antenna port, the respective delay corresponding to a sum of the default delay and the delay offset.

3. The UE of claim 1, wherein, to receive the one or more indications, the one or more processors are individually or collectively operable to execute the code to cause the UE to:
receive a first indication of an average delay associated with the respective second antenna port; and
receive a second indication of a bounding value associated with the respective second antenna port, the respective delay determined by the UE to be within the bounding value of the average delay.

4. The UE of claim 1, wherein, to receive the one or more indications, the one or more processors are individually or collectively operable to execute the code to cause the UE to:
receive an indication of an average delay associated with the respective second antenna port, the respective delay determined by the UE to be within a configured range of the average delay.

5. The UE of claim 1, wherein the one or more processors are individually or collectively further operable to execute the code to cause the UE to:
receive a configuration for sounding reference signal transmission; and
transmit one or more sounding reference signals in accordance with the configuration, wherein reception of the one or more indications of the one or more delay values is based at least in part on transmission of the one or more sounding reference signals in accordance with the configuration.

6. The UE of claim 1, wherein:
reception of the one or more indications comprises reception of a first indication of a first delay value via a first type of control signaling and reception of a second indication of a second delay value via a second type of control signaling, and
transmission of the uplink transmission is based at least in part on reception of the first indication and the second indication.

7. The UE of claim 1, wherein the one or more processors are individually or collectively further operable to execute the code to cause the UE to:
receive a configured grant that allocates a set of resources for uplink transmissions, wherein reception of at least one of the one or more indications is based at least in part on reception of the configured grant.

8. The UE of claim 1, wherein the one or more processors are individually or collectively further operable to execute the code to cause the UE to:
receive one or more second indications of one or more second delay values, each of the one or more second delay values associated with a respective antenna port of the plurality of antenna ports; and
transmit a second uplink transmission based at least in part on generation of a third signal for transmission using the first antenna port and generation of one or more fourth signals for transmission using a respective second antenna port of the plurality of antenna ports, each of the one or more fourth signals having a respective second delay relative to the third signal in accordance with the one or more second delay values.

9. A network entity, comprising:
one or more memories storing processor-executable code; and
one or more processors coupled with the one or more memories and individually or collectively operable to execute the code to cause the network entity to:
output one or more indications of one or more delay values for a user equipment (UE), each of the one or more delay values associated with a respective antenna port of a plurality of antenna ports; and
obtain an uplink transmission from the UE based at least in part on output of the one or more indications of the one or more delay values for the UE.

10. The network entity of claim 9, wherein the uplink transmission is based at least in part on a first signal for transmission using a first antenna port of the plurality of antenna ports and one or more second signals for transmission using a respective second antenna port of the plurality of antenna ports, each of the one or more second signals having a respective delay relative to the first signal in accordance with the one or more delay values.

11. The network entity of claim 9, wherein, to output the one or more indications, the one or more processors are individually or collectively operable to execute the code to cause the network entity to:
output a first indication of a default delay associated with a respective antenna port; and
output a second indication of a delay offset associated with the respective antenna port.

12. The network entity of claim 9, wherein, to output the one or more indications, the one or more processors are individually or collectively operable to execute the code to cause the network entity to:
output a first indication of an average delay associated with a respective antenna port; and
output a second indication of a bounding value associated with the respective antenna port.

13. The network entity of claim 9, wherein, to output the one or more indications, the one or more processors are individually or collectively operable to execute the code to cause the network entity to:
output an indication of an average delay associated with a respective antenna port.

14. The network entity of claim 9, wherein the one or more processors are individually or collectively further operable to execute the code to cause the network entity to:
output a configuration for sounding reference signal transmission; and
obtain one or more sounding reference signals in response to output of the configuration, wherein output of the one or more indications of the one or more delay values is based at least in part on obtaining of the one or more sounding reference signals.

15. The network entity of claim 9, wherein, to output the one or more indications, the one or more processors are individually or collectively operable to execute the code to cause the network entity to:
output a first indication of a first cyclic delay value via a first type of control signaling; and
output a second indication of a second cyclic delay value via a second type of control signaling.

16. The network entity of claim 9, wherein the one or more processors are individually or collectively further operable to execute the code to cause the network entity to:
output a configured grant that allocates a set of resources for uplink transmissions, wherein output of at least one of the one or more indications is based at least in part on output of the configured grant.

17. The network entity of claim 9, wherein the one or more processors are individually or collectively further operable to execute the code to cause the network entity to:
output one or more second indications of one or more second delay values for the user equipment, each of the one or more second delay values associated with a respective antenna port of the plurality of antenna ports; and
obtain a second uplink transmission from the UE based at least in part on output of the one or more second indications of the one or more second delay values for the UE.

18. A method for wireless communications at a user equipment (UE), comprising:
receiving, at the UE, one or more indications of one or more delay values, each of the one or more delay values associated with a respective antenna port of a plurality of antenna ports; and
transmitting, from the UE, an uplink transmission based at least in part on generating a first signal for transmission using a first antenna port of the plurality of antenna ports and generating one or more second signals for transmission using a respective second antenna port of the plurality of antenna ports, each of the one or more second signals having a respective delay relative to the first signal in accordance with the one or more delay values.

19. The method of claim 18, wherein receiving the one or more indications comprises:
receiving a first indication of a default delay associated with the respective second antenna port; and
receiving a second indication of a delay offset associated with the respective second antenna port, the respective delay corresponding to a sum of the default delay and the delay offset.

20. The method of claim 18, wherein receiving the one or more indications comprises:
receiving a first indication of an average delay associated with the respective second antenna port; and
receiving a second indication of a bounding value associated with the respective second antenna port, the respective delay being determined by the UE to be within the bounding value of the average delay.

21. The method of claim 18, wherein receiving the one or more indications comprises:
receiving an indication of an average delay associated with the respective second antenna port, the respective delay being determined by the UE to be within a configured range of the average delay.

22. The method of claim 18, further comprising:
receiving a configuration for sounding reference signal transmission; and
transmitting one or more sounding reference signals in accordance with the configuration, wherein receiving the one or more indications of the one or more delay values is based at least in part on transmitting the one or more sounding reference signals in accordance with the configuration.

23. The method of claim 18, wherein:
receiving the one or more indications comprises receiving a first indication of a first delay value via a first type of control signaling and receiving a second indication of a second delay value via a second type of control signaling, and
transmitting the uplink transmission is based at least in part on receiving the first indication and the second indication.

24. A method for wireless communications by a network entity, comprising:
outputting, from the network entity, one or more indications of one or more delay values for a user equipment (UE), each of the one or more delay values associated with a respective antenna port of a plurality of antenna ports; and
obtaining, at the network entity, an uplink transmission from the UE based at least in part on outputting the one or more indications of the one or more delay values for the UE.

25. The method of claim 24, wherein the uplink transmission is based at least in part on a first signal for transmission using a first antenna port of the plurality of antenna ports and one or more second signals for transmission using a respective second antenna port of the plurality of antenna ports, each of the one or more second signals having a respective delay relative to the first signal in accordance with the one or more delay values.

26. The method of claim 24, wherein outputting the one or more indications comprises:
outputting a first indication of a default delay associated with a respective antenna port; and
outputting a second indication of a delay offset associated with the respective antenna port.

27. The method of claim 24, wherein outputting the one or more indications comprises:
outputting a first indication of an average delay associated with a respective antenna port; and
outputting a second indication of a bounding value associated with the respective antenna port.

28. The method of claim 24, wherein outputting the one or more indications comprises:
outputting an indication of an average delay associated with a respective antenna port.

29. The method of claim 24, further comprising:
outputting a configuration for sounding reference signal transmission; and
obtaining one or more sounding reference signals in response to outputting the configuration, wherein outputting the one or more indications of the one or more delay values is based at least in part on obtaining the one or more sounding reference signals.

30. The method of claim 24, wherein outputting the one or more indications comprises:
outputting a first indication of a first cyclic delay value via a first type of control signaling; and
outputting a second indication of a second cyclic delay value via a second type of control signaling.
